(19) United States
(12) Patent Application Publication
(10) Pub. No.: US 2013/0215381 A1
(43) Pub. Date: Aug. 22, 2013

(54) NESTED SCREW FASTENER

(71) Applicant: Puthalath Koroth Raghuprasad, Odessa, TX (US)

(72) Inventor: Puthalath Koroth Raghuprasad, Odessa, TX (US)

(21) Appl. No.: 13/401,240

(22) Filed: Feb. 21, 2012

(51) Int. Cl. F16B 33/00; B23P 11/00; G02C 13/00; F16B 23/00

(52) U.S. Cl. 351/178; 411/338; 29/407.1

(57) ABSTRACT

A threaded-nested-screw fastener has a first fastener adapted to receive a second fastener. The first fastener has an externally threaded shank extending along the length of the first fastener. The externally threaded shank has an internally threaded opening extending at least partially inside the length of the shank for accepting a second fastener. The second fastener has an externally threaded shank having a thread sized to screw into the internally threaded opening of the threaded shank of the first fastener to form a nested screw assembly.

### TECHNICAL FIELD

This invention relates to a threaded fastener, more particularly to an assembly of two threaded fasteners.

### BACKGROUND OF THE INVENTION

This invention aims to address two problems. The first is the vexing problem with the handling of the delicate screws of spectacles. Due to the space constraints of the spectacle handles, and the need to conceal the screws, the latter are made very short and slim. This small length and girth becomes a very difficult chore when one tries to fix them in their respective threaded opening.

One solution for the problem was proposed by Nancy Tedeschi, U.S. Pat. No. 8,070,403 issued Dec. 6, 2011. In this invention each screw has an extension in the thread end, with a pre-arranged scoring at a strategic location on the screw. This extension makes the handling of the screw easier; after screwing in, the extended portion is snapped off. The problem with this otherwise elegant solution is that, once the end is snapped off, the screw essentially returns to its original, hard-to-handle state.

In the current invention, the main screw has a smaller screw nestled in its threaded or shank end. This inner screw thus serves as the extension. After screwing in, the inner screw is screwed all the way into the outer screw, thus the two screws are securely out of sight. However, when required (to remove the screws), simply extend the smaller screw by un-screwing it completely; this makes the screw combination easier to hold onto and to handle. There can optionally be a provision for preventing the smaller screw from becoming completely dislodged from the outer screw. The ‘head’ of the smaller screw is substantially the same diameter as the threads of the larger screw allowing the head to pass through the threaded opening of the eye glasses.

The second issue is the provision of a suitable alternative fastener; this version aims to replace the nuts in certain circumstances and make the resulting combination more aesthetically pleasing. The idea is to use a smaller-screw-inside a larger screw combination, almost like the foregoing. However, the diameter of the small screw-head is the same or even larger than the main screw's. When fully tightened, this small screw head is flush with the surface and thus hardly noticeable. The main use for this screw-within a screw combination might be for joining two pieces of metal parts or any other solid material, in house or office construction. Other applications might exist, just where nuts and bolts are used. In very thin sheets or panels where the use of rivet fasteners is a common practice for permanent joining, the nested fastener can be used. Rivets must be drilled out to disassemble the sheets. The nested fastener of this invention permits easy removal and disassembly.

### SUMMARY OF THE INVENTION

A nested-screw-fastener has a first fastener adapted to receive a second fastener. The first fastener has an externally threaded shank extending along the length of its body. The externally threaded shank also has an internally threaded opening extending at least partially inside the length of the shank for accepting a second fastener. The second fastener has an externally threaded shank having a thread that is sized to screw into the internally threaded opening of the threaded shank of the first fastener to form a nested screw assembly.

The first fastener has a fastener head extending from an end of the shank of the first fastener. The shank has external threads and the fastener head provides a means to rotate or turn the fastener into a threaded opening. The head can be a flat-head conical shape with a slotted opening for accepting a screw driver.

The second fastener has a fastener head extending from an end of the shank of the second fastener, the fastener head providing a means to rotate or turn the fastener into a threaded opening. The head can be a flat-head conical shape with a slotted opening for accepting a screwdriver. Alternatively, the head can be a rounded pan-head conical shape with a slotted opening for accepting a screwdriver. Generally any commercially available screw fastener with a suitable thread can be used as the second screw.

When combined, the first and second fasteners form a nested screw fastener assembly. The assembly includes a first fastener having an externally threaded shank extending along the length of the first fastener, the externally threaded shank having an internally threaded opening extending at least partially inside the length of the shank for accepting a second fastener; and a second fastener having an externally threaded shank having a thread sized to screw into the internally threaded opening of the threaded shank of the first fastener to form the nested screw assembly.

The assembly provides a method of threading a fastener into an eyeglass frame. This method has the steps of taking a nested screw assembly of a first fastener and second fastener wherein the smaller second fastener extends outwardly from the first fastener thereby increasing the length of screw assembly, and threading a head of the second fastener into a threaded opening of the eyeglass by placing a screwdriver into the head of the first fastener; and screwing the nested screw assembly until the first fastener is fully inserted into the threaded opening of the eyeglass.

The method of threading a fastener into an eyeglass frame further may have the steps of tightening the second fastener by taking a screwdriver and inserting into the head of the second fastener and rotating until the second fastener is fully threaded into the first fastener, thereby shortening the length of the nested fastener assembly.

Alternatively, the use of the nested fastener permits a method of joining two components or sheets of material. That method has the steps of aligning holes in two components or sheets of material; inserting a first fastener with external and internal threads into one end of the aligned holes; inserting a second fastener in the opposite end engaging the internal threads; and tightening the two fasteners. The openings may have counter sunk ends and the two fasteners can have flat head screws to form a flush attachment at the joined surfaces.

### BRIEF DESCRIPTION OF THE DRAWINGS

The invention will be described by way of example and with reference to the accompanying drawings in which:

FIG. 1 is a perspective view of the nested fastener assembly of the present invention.

FIG. 2A is a plan view showing the first outer fastener.

FIG. 2B is a plan view showing the second inner fastener.

FIG. 2C is a longitudinal sectional view showing the first fastener and second fastener fully threaded together.

FIG. 2D is a longitudinal sectional view showing the two fasteners assembled, but extended in length by having the second fastener partially unthreaded from the first fastener.

FIG. 3A is a plan view of a first outer fastener of an alternative embodiment.

FIG. 3B is a plan view of a second inner fastener with a large conical flat head.

FIG. 3C is a longitudinal sectional view showing the first fastener and second fastener joined as an assembly of the two fasteners of the alternative embodiment.

FIG. 4A is a plan view of a first outer fastener of a second embodiment.

FIG. 4B is a plan view of a second inner fastener with a large pan head.

FIG. 4C is a longitudinal sectional view showing the first fastener and second fastener joined as an assembly of the two fasteners of the second alternative embodiment.

FIG. 5A is a longitudinal sectional view of the first fastener and second fastener of the first alternative embodiment shown fastening two components or sheets of material together.

FIG. 5B is a longitudinal sectional view of the first fastener and second fastener of the second alternative embodiment shown fastening two components or sheets of material together.

FIG. 6 is a perspective view of an eyeglass frame shown with the nested fastener assembly of FIG. 1 inserted into a threaded opening, with the smaller fastener in the extended position.

FIG. 7A is a view showing the nested fastener assembly just prior to insertion into a threaded opening of an eyeglass frame.

FIG. 7B illustrates how the larger first fastener is threaded fully into the opening in the frame, while the smaller extended fastener is still extended.

FIG. 7C shows how the second fastener is screwed fully into the larger first fastener to complete the assembly.

### DETAILED DESCRIPTION OF THE INVENTION

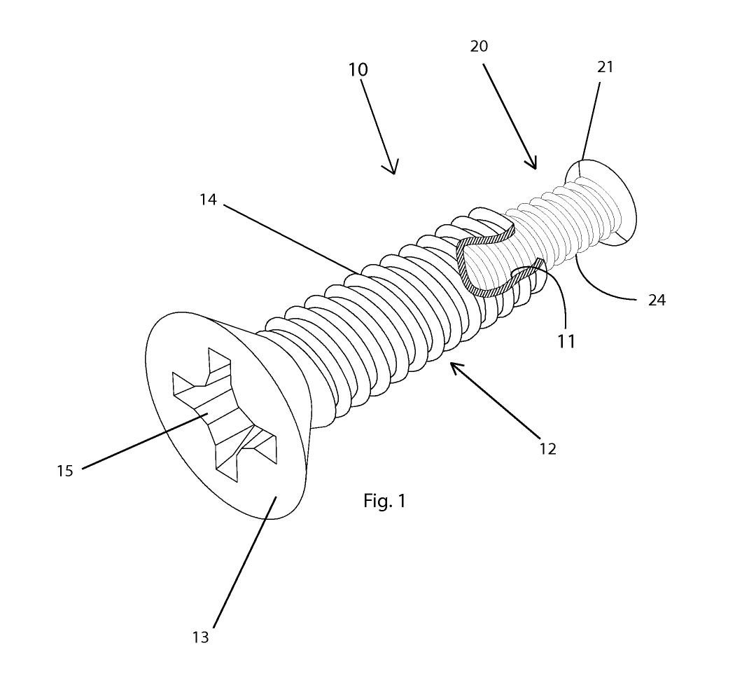

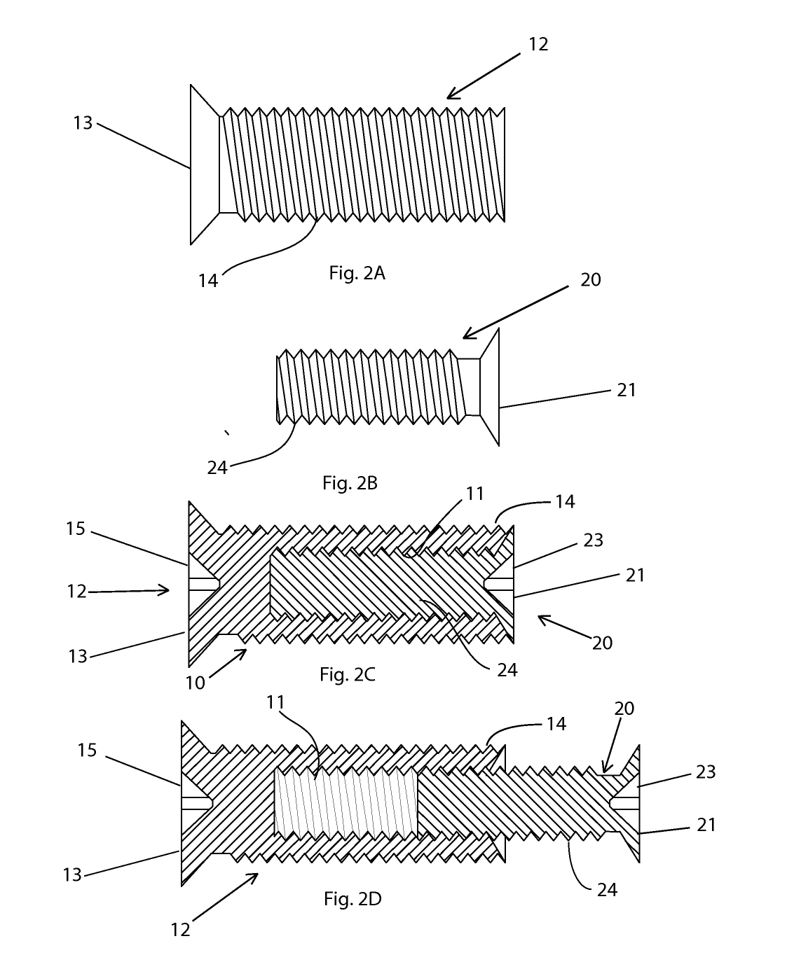

With reference to FIGS. 1-2D, a nested-screw-fastener assembly 10 is illustrated. As shown in FIG. 1, the nested first fastener 12 has a second fastener 20 shown inserted into the internally threaded opening 11 of the hollow externally threaded shank 14 of the first fastener 12 to make the assembly 10. The first fastener 12 has an enlarged head 13. As illustrated, a conical flat head 13 with opening slots 15 for receiving a screwdriver is at one end of the shank 14. The shank 14 of the first fastener 12 is threaded in such a fashion that it can be screwed into an opening having complimentary threads. As further shown in FIG. 1, the second fastener 20 has a small head 21 and a threaded shank 24. As illustrated in FIG. 2A, the first fastener 12 is illustrated in a plan view and the second fastener 20 is illustrated as shown in FIG. 2B. The large first fastener 12 is shown in FIGS. 2C and 2D with the second fastener 20 inserted into internal threads in the hollow threaded opening 11 of the shank 14. As shown in FIG. 2C, the second fastener 20 is shown fully threaded into the nested fastener 12. With reference to FIG. 2D, the second fastener 20 is shown extended outwardly only partially threadingly engaged to the first fastener 12. The second fastener 20 has a slotted end 23 for receiving a screwdriver as illustrated in FIGS. 2C and 2D.

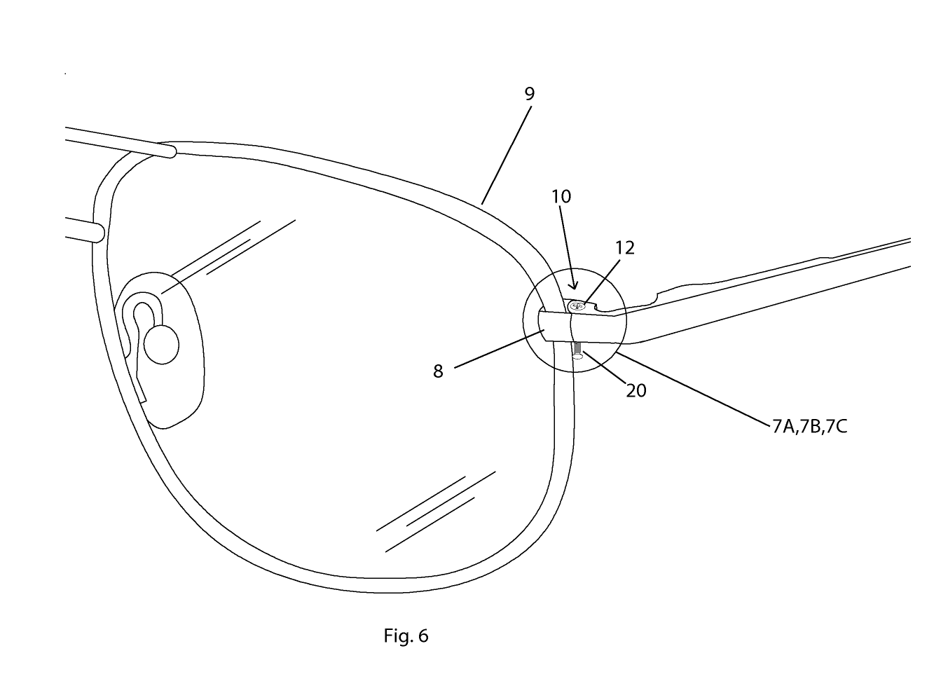

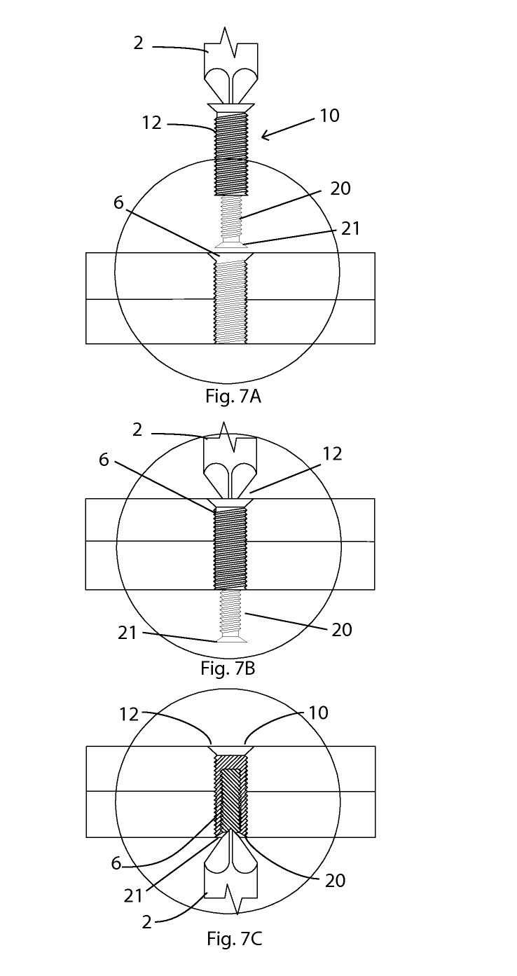

With reference to FIGS. 6 and 7A-7C, a perspective view of a portion of an eyeglass is shown. These spectacles 9, as illustrated, have the nested-screw-fastener assembly 10 having both the first fastener 12 and the smaller second fastener 20 assembled in such a fashion that they can facilitate attaching the eyeglass frame components fastened together at the hinge location 8. FIG. 7A shows how the fastener assembly 10 can be used to make an attachment of the eyeglass frames. In this assembly, the secondary fastener 20 is shown extended partially out of the first fastener 12 thereby increasing the length of the fastener assembly 10. This increased length facilitates handling of the short screws used in affixing eyeglass frames. In FIG. 7A, the small head 21 of the second fastener 20 is sized to complimentarily fit into the threaded opening 6 on the eyeglass hinge. This head 21 can then be threadingly passed through the opening 6 of the hinge all the way guiding the fastener assembly 10 in such a fashion that the first fastener 12 then comes into engagement with the threads and is securely screwed into the eyeglass threaded opening 6. This is illustrated in FIG. 7B wherein the first fastener 12 is shown fully inserted into the threaded opening 6 of the eyeglass frame 9. Once the screwdriver 2 makes a complete insertion of the assembly 10 in the final step the screwdriver 2 is moved into the small head 21 of the second fastener 20 in such a fashion that it is then tightened, shortening the length of the fastener assembly 10 until the second fastener 20 is fully inserted into the first fastener 12. Once this is accomplished, a secure fit is achieved and the flush fitting of the fastener assembly 10 is accomplished. On removal of the fastener assembly 10, one would reverse the sequence and can extend the length of the assembly 10 if so desired, then remove the assembly 10 or alternatively can simply back out the entire assembly 10. However, upon reinsertion the user will find it convenient to extend the length again prior to making the assembly thus increasing the overall convenience of making this attachment. It is a common practice for such small screws to be dropped, lost or fumbled with on assembly and it is also rather difficult to make the initial insertion such that the threads can be easily started. With the use of the fastener assembly 10 this is accomplished with relative ease.

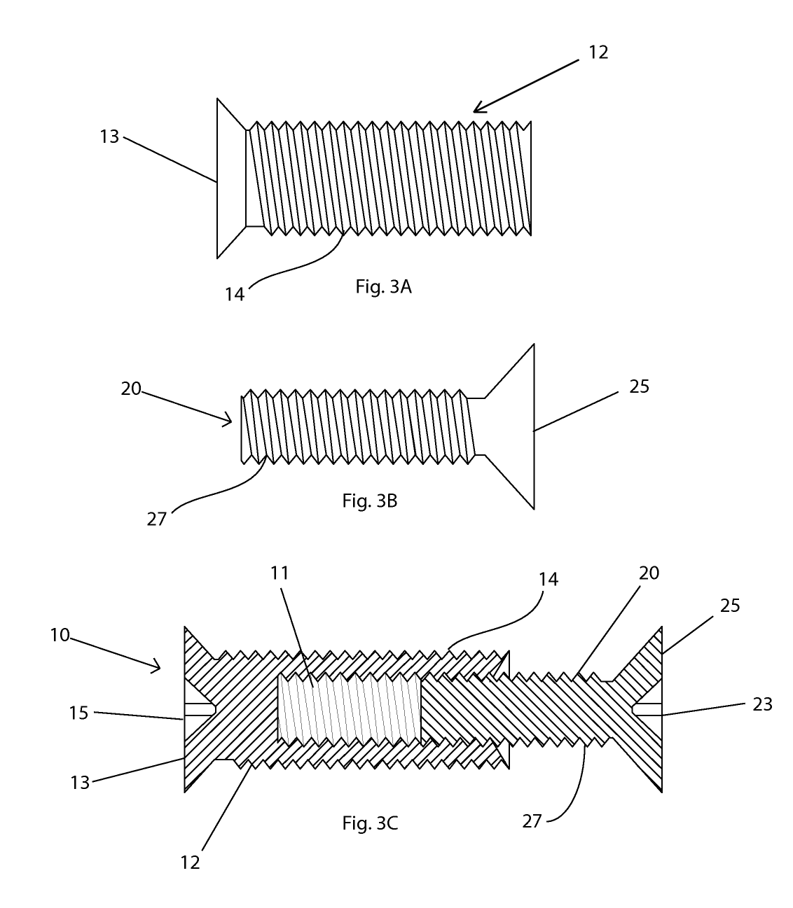

In an alternative embodiment illustrated in FIGS. 3A-3C, another nested-screw-fastener assembly 10 is shown. The first fastener 12 is identical to that of FIG. 1 and has the threaded shank 14, the enlarged head 13 and the hollow internal threaded opening 11 for receiving a secondary screw or fastener 20. As shown in FIG. 3A, the large first fastener again has reference numeral 12. In FIG. 3B, the second fastener is illustrated by reference numeral 20. It has a threaded shank 27 and an enlarged head end 25. This enlarged head end 25 is equal to or greater in size than the head 13 of the first fastener 12. In FIG. 3C, the first fastener 12 forms an assembly 10 wherein the first fastener 12 is shown with a hollow interior opening 11 that is threaded, this threaded interior opening 11 as shown allows for the threads on the threaded shank 27 to be received in such a fashion that the two fasteners 12, 20 can be joined together.

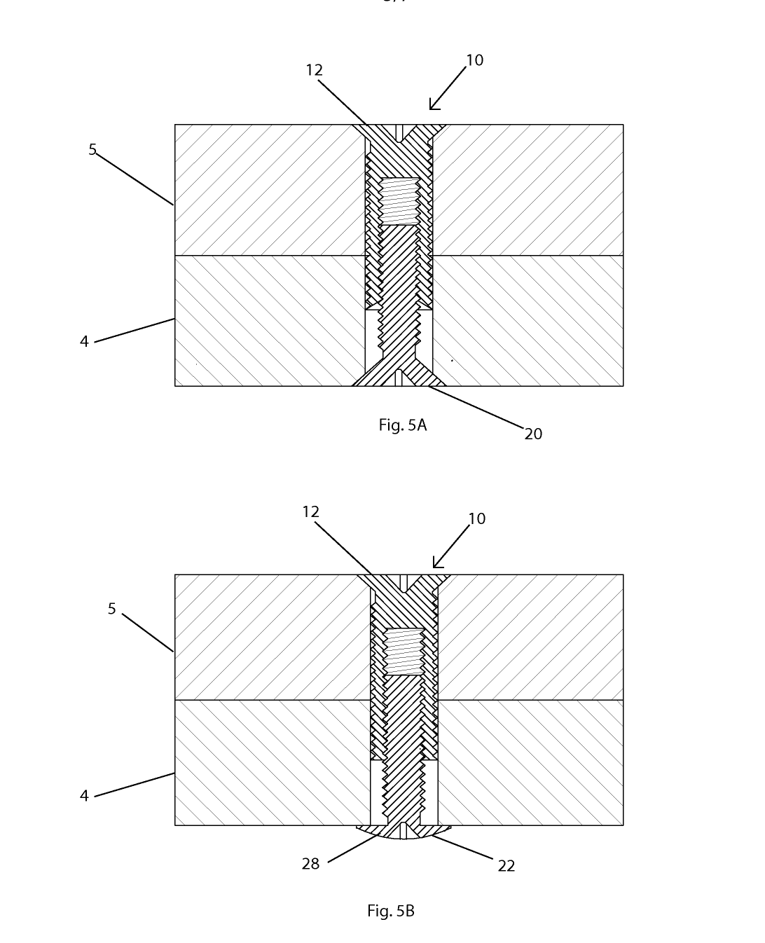

With reference to FIG. 5A, two blocks or components or sheets of material are illustrated, these sheets 5 and 4 are shown joined together by the fastener assembly 10 wherein the first fastener 12 is shown in the upper portion of FIG. 5A and the second fastener 20 is shown threaded into the first fastener 12 whereby the enlarged flat heads of the fasteners are illustrated being positioned into the components 5 and 4 in such a manner that they are countersunk and flush such that the joining of the two components 4, 5 can be achieved wherein the threaded fasteners 12, 20 are joined flush to the surfaces. This assembly allows for very thin panels to be joined together in such a fashion that they do not require riveting. Heretofore, the only way to fasten such materials is to run a fastener through and thread one of the thin panels or alternatively to extend it through and provide a nut that is external to the components.

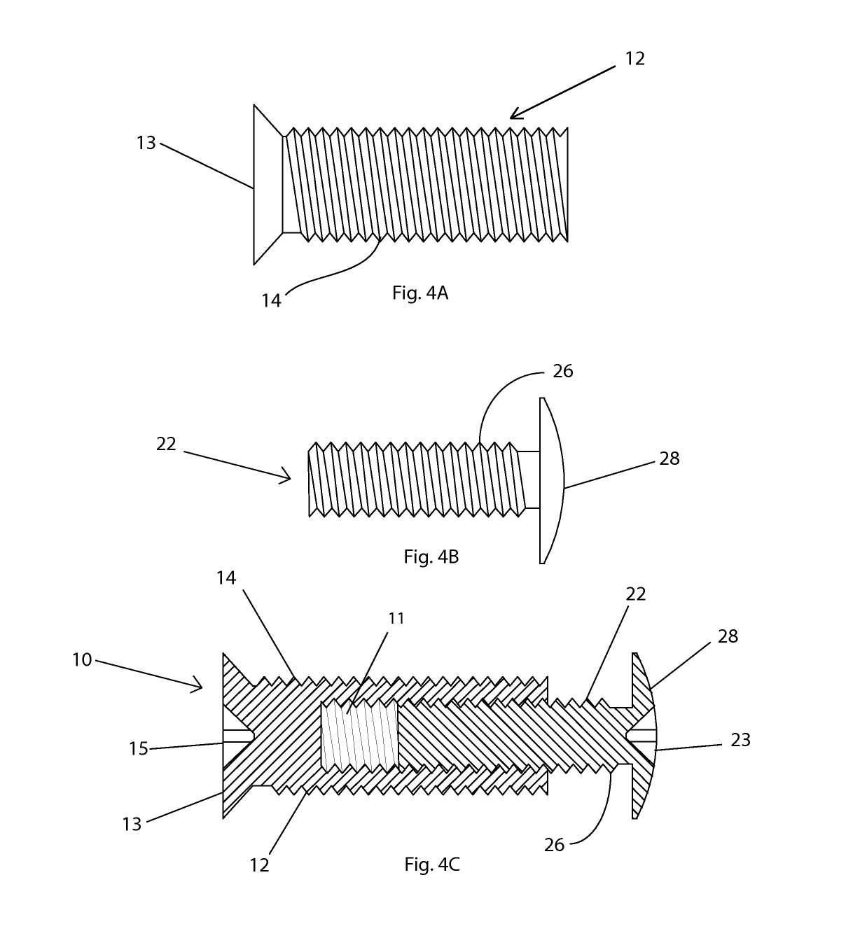

With reference to FIGS. 4A-4C, a second alternative embodiment is shown. In this embodiment, the first fastener 12 is identical to that as in the other figures. However, in FIG. 4B, the second fastener 22 is shown with a pan-head-type screw head 28. In this assembly, shown in 4C, the pan-head 28 type fastener assembly is threaded into the internal threads 11 of the fastener 12 to form the assembly 10.

With reference to FIG. 5B, this alternative assembly 10 is shown fastening two components 4 and 5 together in a similar fashion to that shown in FIG. 5A. Again, in this component only the upper surface is flush, however, a counterbore could have been provided in the lower surface such that the pan head 28 of the second fastener 22 could have been concealed; this is possible when the material is relatively thick and the counterbore would not adversely affect the strength of the joining If in fact the materials are thin, it is preferable to use the conical-shaped flat heads illustrated in FIG. 5A to make a flush fit. The advantages of the fastener assembly 10 as illustrated are that components can be joined together in such a fashion, eliminating the need for nuts or threading the component to be attached. It is understood that while the fasteners 12, 20 are illustrated with flat heads 21 or pan heads 28, any alternative head could be provided with such a fastener including hex heads or internal socket type heads which would allow for Allen type wrenches to be used in the threaded-nested assembly 10 of the two fasteners 12, 20. Although these alternatives are not illustrated, it is well understood in the art that these alternatives could be used in the fabrication of the fasteners as described. Alternatively, the shank 14 of the first fastener 12 while shown with a threaded external thread could be a smooth shank on the first fastener 12 in such a fashion that the first fastener 12 is only provided internal threads so that when joined the two fasteners 12, 20 can be joined together. This works perfectly well when the fastener assembly 10 is joining through holes as illustrated in FIGS. 5A or 5B. Alternatively if desired, one of the assembled component could be threaded such that the external threads would extend into one of the components and threadingly engage the first fastener 12 and the second fastener 20 being smaller in diameter would simply pass through the treaded portion of the component being attached. These and other alternatives are well within the scope of the invention. It is further understood that while the threaded fastener is shown as an assembly 10, it is also claimed as a single component. This is because the first fastener 12 can have an internal thread 11 that will accept any conventional screw, which will enable the second fastener 20 to be purchased separately from the first fastener 12, as such any assembled length of the secondary screw 20 is possible. One would simply select the amount of threads that they need for the secondary screw 20.

Further, it is to be appreciated that the nested-screw-fastener assembly 10 shown with threads extending all the way on the second fastener 20 could be made such that the threaded portion of the second fastener 20 can have threads only at one end and a smaller smooth diameter shank positioned between the thread and the head. In this fashion, the threaded end of the larger diameter first fastener 12 can be crimped over after the two fasteners 12, 20 are assembled so they cannot be separated. While this is not illustrated, it is clearly understood within the scope of the invention that a feature preventing the two components from being dislodged is feasible and is within the scope of the invention. This is useful only in the cases where the assembly 10 is ideally never taken apart. In the embodiment shown in FIGS. 5A and 5B, by design these are ideally assembled in such a fashion that they can be separated. The advantage of separating the fasteners 12, 20, 22 and inserting them from each side of the components 4,b5 being joined is that the person assembling the two fasteners 12, 20 can use two screwdrivers to simultaneously turn the fasteners in a fashion that will enable them to securely lock the components together joining them. Additionally, washers or lock washers not illustrated, can be used in combination with these nested fastener assemblies 10 on the first fastener 12 or second fastener 20, 22 if so desired. Additionally, self-locking screw features can be provided which are well known in the art. These and other alternatives are considered well within the scope of the present invention.

As used herein the term “fastener” is used to describe any threaded device having a shank and a head. Commonly, various screws and bolts are considered fasteners. These include, but are not limited to flat head, pan head, hex head, screws, carriage bolts, shoulder bolts, etc. by way of example. The distinguishing feature of the present invention is the shank has an internally threaded opening to receive a second threaded fastener. In fact, while the first fastener is shown with threads along the external shank these threads are optional and not required to make the nested assembly of the first and second fastener. The external threads can be along the entire shank or a portion of the shank.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A nested screw fastener comprises:
a first fastener having an externally threaded shank extending along the length of the first fastener, the externally threaded shank having an internally threaded opening extending at least partially inside the length of the shank for accepting a second threaded fastener.

2. The nested screw fastener of claim 1 further comprises:
a second fastener having an externally threaded shank having a thread that is sized to screw into the internally threaded opening of the threaded shank of the first fastener to form the nested screw assembly.

3. The nested screw fastener of claim 1 further comprises:
a fastener head extending from an end of the shank of the first fastener, the shank having external threads; the fastener head providing a means to rotate or turn the fastener into a threaded opening.

4. The nested screw fastener of claim 3 wherein the head is a flat head conical shape with a slotted opening for accepting a screwdriver.

5. The nested screw fastener of claim 2 further comprises:
a fastener head extending from an end of the shank of the second fastener, the fastener head providing a means to rotate or turn the fastener into a threaded opening.

6. The nested screw fastener of claim 5 wherein the head is a flat head conical shape with a slotted opening for accepting a screwdriver.

7. The nested screw fastener of claim 5 wherein the head is a rounded pan head conical shape with a slotted opening for accepting a screwdriver.

8. A nested screw fastener assembly comprises:
a first fastener having an externally threaded shank extending along the length of the first fastener, the externally threaded shank having an internally threaded opening extending at least partially inside the length of the shank for accepting a second threaded fastener; and
a second fastener having an externally threaded shank having a thread sized to screw into the internally threaded opening of the threaded shank of the first fastener to form the nested screw assembly.

9. The nested screw fastener assembly of claim 8 further comprises:
a fastener head extending from an end of the shank of the first fastener, the shank having external threads; the fastener head providing a means to rotate or turn the fastener into a threaded opening.

10. The nested screw fastener assembly of claim 9 wherein the head is a flat head conical shape with a slotted opening for accepting a screwdriver.

11. The nested screw fastener assembly of claim 8 further comprises:
a fastener head extending from an end of the shank of the second fastener, the fastener head providing a means to rotate or turn the fastener into a threaded opening.

12. The nested screw fastener assembly of claim 11 wherein the head is a flat head conical shape with a slotted opening for accepting a screwdriver.

13. The nested screw fastener assembly of claim 11 wherein the head is a rounded pan head conical shape with a slotted opening for accepting a screwdriver.

14. The nested screw fastener assembly of claim 12 wherein the flat head conical shape has an outside diameter less than or equal to the external threads diameter allowing said head to be threaded through a threaded opening sized for the first fastener.

15. A method of threading a fastener into an eyeglass frame comprises the steps of:
taking a nested screw assembly of a first fastener and second fastener wherein the smaller second fastener extends outwardly from the first fastener, thereby increasing the length of the screw assembly and threading a head of the second fastener into a threaded opening of the eyeglass by placing a screwdriver into the head of the first fastener;
screwing the nested screw assembly until the first fastener is fully inserted into the threaded opening of the eyeglass.

16. The method of threading a fastener into an eyeglass frame of claim 15 further comprises the steps of:
tightening the second fastener by taking a screwdriver and inserting into a head of the second fastener and rotating until the second fastener is fully threaded into the first fastener, thereby shortening the length of the nested fastener assembly.

17. A method of joining two components or sheets of material comprises the steps of:
aligning holes in two components or sheets of material;
inserting a first nested fastener with a shank with external and internal threads into one end of the aligned holes;
inserting a second threaded fastener in the opposite end engaging the internal threads; and
tightening the two fasteners.

18. The method of joining two components or sheets of material of claim 17 wherein the openings have counter-sunk-ends and the two fasteners have flat head screws to form a flush attachment at the joined surfaces.
